(19) United States
(12) Patent Application Publication
(10) Pub. No.: US 2025/0128571 A1
(43) Pub. Date: Apr. 24, 2025

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Jeawan Kim, Hwaseong-si (KR); Yong Woong Cha, Yongin-si (KR); Hochan An, Hwaseong-si (KR); Wan Je Cho, Hwaseong-si (KR); Seong-Bin Jeong, Hwaseong-si (KR); Gwi Taek Kim, Cheonan-si (KR); Hoyoung Jeong, Hwaseong-si (KR); Man Hee Park, Suwon-si (KR); Yeong Jun Kim, Incheon (KR); Jae Yeon Kim, Hwaseong-si (KR); Yeonho Kim, Seoul (KR)

(73) Assignees: HYUNDAI MOTOR COMPANY, Seoul (KR); KIA CORPORATION, Seoul (KR)

(21) Appl. No.: 18/612,357

(22) Filed: Mar. 21, 2024

(30) Foreign Application Priority Data
Oct. 19, 2023 (KR) 10-2023-0140279

(51) Int. Cl. B60H 1/00

(52) U.S. Cl. CPC B60H 1/00921; B60H 1/00278; B60H 2001/00307; B60H 2001/00928; B60H 2001/00949

(57) ABSTRACT

A heat pump system for a vehicle is provided to improve cooling and heating performance by applying a gas injection device selectively operating during air conditioning of a vehicle interior by increasing a flow rate of the refrigerant circulating in a refrigerant line of the heat pump system. The heat pump system for a vehicle may include: a compressor, a first condenser, a receiver dryer, a second condenser, an evaporator, a gas injection device, a refrigerant connection line, and a chiller. The flow of the refrigerant is controlled according to at least one mode for adjusting a temperature of a vehicle interior or adjusting a temperature of a battery module.

### CROSS-REFERENCE TO RELATED APPLICATION

This application claims priority to and the benefit of Korean Patent Application No. 10-2023-0140279 filed on Oct. 19, 2023, the entire contents of which are incorporated herein by reference.

### BACKGROUND

### (a) Field

The present disclosure relates to a heat pump system for a vehicle. More particularly, the present disclosure relates to a heat pump system for a vehicle capable of improving cooling and heating performance.

### (b) Description of the Related Art

Generally, an air conditioning system for a vehicle includes an air conditioner unit circulating a refrigerant in order to heat or cool an interior of the vehicle.

The air conditioner unit is used to maintain the interior of the vehicle at an appropriate temperature regardless of a change in an external temperature. The air conditioner unit is configured to heat or cool the interior of the vehicle. This is achieved by exchanging heat using a condenser and an evaporator in a process in which a refrigerant discharged by driving a compressor is circulated back to the compressor through the condenser, a receiver drier, an expansion valve, and the evaporator.

In other words, the air conditioner unit lowers the temperature and the humidity of the interior of the vehicle by condensing a high-temperature high-pressure gas-phase refrigerant compressed from the compressor by the condenser, passing the refrigerant through the receiver drier and the expansion valve, and then evaporating the refrigerant in the evaporator in a cooling mode.

In accordance with a continuous increase in interest in energy efficiency and environmental pollution problems, the development of an environmentally-friendly vehicle capable of substantially substituting for an internal combustion engine vehicle is required. The environmentally-friendly vehicle is classified into an electric vehicle driven using a fuel cell or electricity as a power source and a hybrid vehicle driven using an engine and a battery.

Among these environmentally-friendly vehicles, a separate heater is not used unlike an air conditioner of a general vehicle. An air conditioner used in the environmentally-friendly vehicle is generally called a heat pump system.

The electric vehicle driven by a power source of a fuel cell generates driving force by converting chemical reaction energy between oxygen and hydrogen into electrical energy. In this process, heat energy is generated by a chemical reaction in a fuel cell. Therefore, it is necessary to secure the performance of the fuel cell to effectively remove generated heat.

In addition, the hybrid vehicle generates driving force by driving a motor using electricity supplied from the fuel cell described above or an electrical battery, together with an engine operated by general fuel. Therefore, heat generated from the fuel cell, or the battery and the motor should be effectively removed in order to secure the performance of the motor.

Therefore, in the hybrid vehicle or the electric vehicle according to the related art, a cooling means, a heat pump system, and a battery cooling system, respectively, are configured as separate closed circuits so as to prevent heat generation from the motor, an electric component, and the battery including a fuel cell.

Therefore, the size and weight of a cooling module disposed at the front of the vehicle are increased, and a layout of connecting pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain optimal performance of the battery, a plurality of valves for selectively interconnecting connecting pipes are employed. As a result, noise and vibration due to the frequent opening and closing operations of the valves may be introduced into the vehicle interior, thereby deteriorating ride comfort.

In addition, when heating the vehicle interior, the heating performance may deteriorate due to the lack of a heat source. The electricity consumption may be increased due to the usage of the electric heater, and the power consumption of the compressor may be increased.

The above information disclosed in this Background section is only to enhance understanding of the background of the disclosure. Therefore, the Background section may contain information that does not form the prior art that is already to a person of ordinary skill in the art.

### SUMMARY

The present disclosure provides a heat pump system for a vehicle capable of improving cooling and heating performance by applying a gas injection device selectively operating during air conditioning of the vehicle interior by increasing an amount of refrigerant.

In one embodiment of the present disclosure, a heat pump system for a vehicle is provided. The heat pump system may include: a compressor configured to compress a refrigerant, and a first condenser connected to the compressor through a refrigerant line. The first condenser may be configured to receive and condense the refrigerant supplied from the compressor by exchanging heat between the refrigerant and a coolant. The heat pump system may also include: a receiver dryer connected to the first condenser through the refrigerant line, a second condenser connected to the receiver dryer through the refrigerant line, and an evaporator connected to the second condenser through the refrigerant line. The evaporator may be configured to evaporate the refrigerant by exchanging heat between the refrigerant supplied from the second condenser and a selectively introduced coolant. The heat pump system may also include a gas injection device connected to the refrigerant line between the second condenser and the evaporator. The gas injection device may be configured to selectively expand and flow the refrigerant supplied from the second condenser, and further configured to selectively supply a portion of the supplied refrigerant to the compressor to increase an flow rate of the refrigerant circulating in the refrigerant line of the heat pump system. The heat pump system may also include a refrigerant connection line disposed between the compressor and the evaporator, and having a first end connected to the refrigerant line and a second end connected to the gas injection device. The heat pump system may also include a chiller provided in the refrigerant connection line, and configured to adjust the temperature of the coolant by exchanging heat between the refrigerant supplied into the refrigerant connection line and the selectively introduced coolant. The flow of the refrigerant is controlled according to at least one mode for adjusting the temperature of a vehicle interior or adjusting a temperature of a battery module.

The gas injection device may include: a supply portion connected to the second condenser through the refrigerant line such that the refrigerant supplied from the second condenser may be introduced; and a gas-liquid separator configured to separate and selectively discharge a gaseous refrigerant and a liquid refrigerant from the refrigerant supplied by the supply portion. The gas injection device may also include a first expansion valve provided between the gas-liquid separator and the supply portion. The first expansion valve may be configured to selectively expand the refrigerant supplied to the supply portion and supply the expanded refrigerant to the gas-liquid separator. The gas injection device may also include a second expansion valve provided between the gas-liquid separator and the supply portion. The second expansion valve may be configured to either selectively expand the refrigerant supplied to the supply portion and supply the expanded refrigerant to the chiller, or supply the refrigerant supplied from the gas-liquid separator to the chiller. The gas injection device may also include a third expansion valve provided between the gas-liquid separator and the supply portion. The third expansion valve may be configured to either selectively expand the refrigerant supplied to the supply portion and supply the expanded refrigerant to the evaporator, or supply the refrigerant supplied from the gas-liquid separator to the evaporator. The gas injection device may also include a discharge portion connecting the gas-liquid separator, the second expansion valve, and the third expansion valve, and configured to discharge the refrigerant from the gas-liquid separator to the second expansion valve or the third expansion valve. Additionally, the gas injection device may include a supply line connecting the gas-liquid separator and the compressor, and configured to selectively supply the gaseous refrigerant from the gas-liquid separator to the compressor.

The second expansion valve and the third expansion valve may be disposed in parallel with the first expansion valve through the supply portion and the discharge portion.

The first, second, and the third expansion valves may be selectively operated at the time of air-conditioning (i.e., cooling, heating, and dehumidifying) of the vehicle interior. Additionally, the first, second, and third expansion valves selectively expand the refrigerant by the gas injection device while controlling the flow of the supplied refrigerant.

The gas-liquid separator may be operated when the first expansion valve may expand the refrigerant, and may be configured to supply the gaseous refrigerant among the supplied refrigerant to the compressor through the supply line to increase the flow rate of the refrigerant circulating in the refrigerant line.

The at least one mode may include: i) a first mode in which the gas-liquid separator is operated, and the battery module is cooled while the vehicle interior is cooled; ii) a second mode in which the gas-liquid separator is operated and the vehicle interior is heated; iii) a third mode in which the gas-liquid separator is not operated and the battery module is cooled while cooling the vehicle interior; iv) a fourth mode in which the gas-liquid separator is not operated and the vehicle interior is heated; or any combination thereof.

In the first mode: the first expansion valve may expand the refrigerant supplied through the supply portion and supply the expanded refrigerant to the gas-liquid separator; and the second expansion valve may expand the refrigerant supplied from the gas-liquid separator through the discharge portion and may flow the expanded refrigerant to the refrigerant connection line connected to the chiller. Additionally, in the first mode: the third expansion valve may expand the refrigerant supplied from the gas-liquid separator through the discharge portion and may flow the expanded refrigerant to the refrigerant line; the supply line may be opened; and the gas-liquid separator may be configured to supply the gaseous refrigerant among the refrigerant supplied by the supply portion to the compressor through the opened supply line.

In the second mode: the first expansion valve may expand the refrigerant supplied through the supply portion and supply the expanded refrigerant to the gas-liquid separator; and the second expansion valve may expand the refrigerant supplied from the gas-liquid separator through the discharge portion and may flow the expanded refrigerant to the refrigerant connection line connected to the chiller. In addition, in the second mode: the third expansion valve may stop operating; the supply line may be opened; and the gas-liquid separator may be configured to supply the gaseous refrigerant among the refrigerant supplied by the supply portion to the compressor through the opened supply line.

In the third mode: the first expansion valve may stop operating, thereby stopping the flow of the refrigerant to the gas-liquid separator; and the second expansion valve may expand the refrigerant supplied through the supply portion and supply the expanded refrigerant to the gas-liquid separator through the refrigerant connection line. Additionally, in the third mode: the third expansion valve may expand the refrigerant supplied through the supply portion and supply the expanded refrigerant to the gas-liquid separator through the refrigerant line; and the supply line may be closed.

In the fourth mode: the first expansion valve and the third expansion valve may stop operating, thereby stopping the flow of the refrigerant to the gas-liquid separator; and the second expansion valve may expand the refrigerant supplied through the supply portion and may flow the expanded refrigerant to the refrigerant connection line connected to the chiller. Additionally, in the fourth mode, the supply line may be closed.

The second expansion valve and the third expansion valve may be 3-way electronic expansion valves having two inlets and one outlet, and configured to selectively expand the refrigerant while controlling the flow of the refrigerant.

A heat pump system for a vehicle may further include a cooling apparatus including a radiator and an electrical component. The cooling apparatus may be connected to the battery module. The first condenser may be connected to the cooling apparatus through a first line through which the coolant circulates, and connected to a heater core through a second line through which the coolant circulates.

In a cooling mode and a heating mode of the vehicle interior, the first line may be selectively opened to supply the coolant to the first condenser.

In a heating mode of the vehicle interior, the second line may be opened to connect the first condenser and the heater core.

The evaporator may be connected to a cabin cooler through a third line through which the coolant circulates.

In a cooling mode of the vehicle interior, the third line may be opened to connect the evaporator and the cabin cooler.

The chiller may be connected to the cooling apparatus through a fourth line through which the coolant circulates, and connected to the battery module through a fifth line through which the coolant circulates.

In a heating mode of the vehicle interior, when waste heat of the electrical component and ambient air heat is to be recollected, the fourth line may be opened to connect the cooling apparatus and the chiller.

When cooling the battery module in a cooling mode of the vehicle interior, or when a waste heat of the battery module is to be recollected in a heating mode of the vehicle, the fifth line may be opened to connect the chiller and the battery module.

As described above, according to a heat pump system for a vehicle according to an embodiment, cooling and heating performance may be improved by applying a gas injection device selectively operating during air conditioning of the vehicle interior to increase an flow rate of the refrigerant circulating in a refrigerant line of the heat pump system.

In addition, according to the present disclosure, performance of the system may be maximized by using the gas injection device while minimizing the number of required components, and thus streamlining and simplification of the system may be achieved.

In addition, according to an embodiment, it is possible to reduce manufacturing cost and weight through simplification of an entire system, and to improve space utilization.

### BRIEF DESCRIPTION OF THE DRAWINGS

These drawings are for reference only in describing embodiments of the present disclosure. Therefore, the technical idea of the present disclosure should not be limited to the accompanying drawings.

FIG. 1 is a block diagram illustrating a heat pump system for a vehicle according to an embodiment.

FIG. 2 is an operation diagram illustrating a heat pump system for a vehicle according to an embodiment, in a first mode.

FIG. 3 is an operation diagram illustrating a heat pump system for a vehicle according to an embodiment, in a second mode.

FIG. 4 is an operation diagram illustrating a heat pump system for a vehicle according to an embodiment, in a third mode.

FIG. 5 is an operation diagram illustrating a heat pump system for a vehicle according to an embodiment, in a fourth mode.

The drawings described herein are for illustration purposes only and are not intended to limit the scope of the present disclosure in any way.

### DETAILED DESCRIPTION

Embodiments of the present disclosure are hereinafter described in detail with reference to the accompanying drawings.

The embodiments disclosed in the present disclosure and the constructions depicted in the drawings are only some of the embodiments of the present disclosure, and do not cover the entire scope of the present disclosure. Therefore, it should be understood that there may be various equivalents and variations at the time of the application of this specification.

In order to clarify the present disclosure, parts that are not related to the description have been omitted, and the same elements or equivalents have been referred to with the same reference numerals throughout the specification.

Also, the size and thickness of each element are arbitrarily shown in the drawings, but the present disclosure is not necessarily limited thereto.

Additionally, in the drawings, the thickness of layers, films, panels, regions, and the like, are exaggerated for clarity.

In addition, unless explicitly described to the contrary, the words “comprise” and variations such as “comprises” or “comprising,” should be understood to imply the inclusion of stated elements but not the exclusion of any other elements.

Furthermore, each of terms, such as “ . . . unit,” “ . . . means,” “ . . . portions,” “ . . . part,” and “ . . . member” described in the specification, mean a unit of a comprehensive element that performs at least one function or operation.

When a component, device, element, or the like of the present disclosure is described as having a purpose or performing an operation, function, or the like, the component, device, or element should be considered herein as being “configured to” meet that purpose or perform that operation or function.

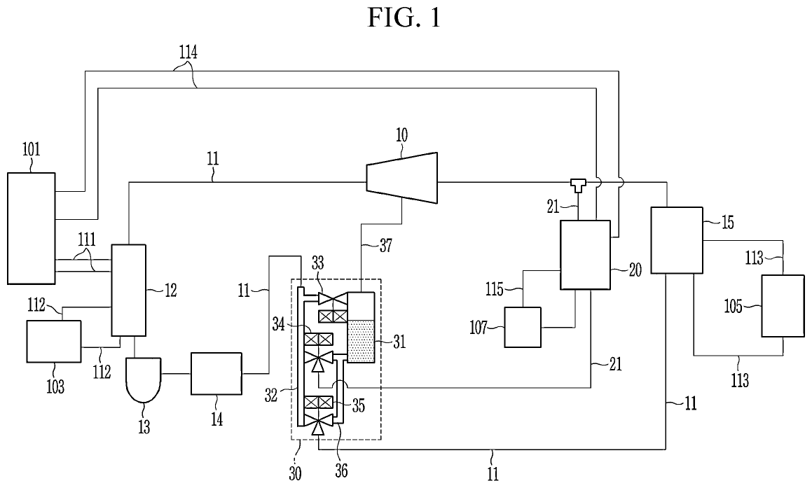

FIG. 1 is a block diagram illustrating a heat pump system of a vehicle according to an embodiment.

A heat pump system for a vehicle according to an embodiment may improve cooling and heating performance by employing a gas injection device 30 selectively operated in a selected mode among a cooling mode or a heating mode of a vehicle interior.

In the heat pump system of an electric vehicle, a cooling apparatus circulating a coolant may be interconnected with an air conditioner unit that is an air-conditioner apparatus for cooling and heating the vehicle interior.

Referring to FIG. 1, the heat pump system may include the cooling apparatus and the air conditioner unit having a compressor 10, a first condenser 12, a receiver dryer 13, a second condenser 14, an evaporator 15, a chiller 20, a refrigerant connection line 21, and a gas injection device 30.

First, a cooling apparatus 101 may include a radiator (not illustrated) and an electrical component (not illustrated) connected by a coolant line through which coolant circulates. In addition, the cooling apparatus 101 may be connected to a battery module 107 through a separate coolant line through which coolant circulates.

The radiator may be disposed in a frontal region of the vehicle. A cooling fan (not shown) may be provided at a rear of the radiator. Accordingly, the radiator may cool the coolant through an operation of the cooling fan exchanging heat with ambient air.

The cooling apparatus 101 may be connected to the first condenser 12 through a first line 111 through which coolant circulates, and may be connected to the chiller 20 through a fourth line 114 through which coolant circulates.

In addition, the first condenser 12 may be connected to a heater core 103 through a second line 112 through which coolant circulates. Accordingly, the coolant having an increased temperature by exchanging heat with the refrigerant in the first condenser 12 may be supplied to the heater core 103 through the second line 112, in the heating mode of the vehicle interior.

The high-temperature coolant supplied to the heater core 103 may heat the ambient air passing through the heater core 103. In other words, since the introduced ambient air is converted to a high-temperature state while passing through the heater core 103 and then introduced into the vehicle interior, the heating of the vehicle interior may be realized.

The first line 111 may be selectively opened so as to supply the coolant to the first condenser 12 in the cooling mode and the heating mode of the vehicle interior.

In addition, in the heating mode of the vehicle interior, the second line 112 may be opened to connect the first condenser 12 and the heater core 103.

The evaporator 15 may be connected to a cabin cooler 105 through a third line 113 through which coolant circulates. Accordingly, the coolant having a deteriorated temperature by exchanging heat with the refrigerant in the evaporator 15 may be supplied to the cabin cooler 105 through the third line 113, in the cooling mode of the vehicle interior.

The ambient air passing through the cabin cooler 105 may be cooled while passing through the cabin cooler 105 by the low-temperature coolant supplied to the cabin cooler 105. Since the cooled ambient air is introduced into the vehicle interior, the vehicle interior may be cooled.

In other words, in the cooling mode of the vehicle interior, the third line 113 may be opened to connect the evaporator 15 and the cabin cooler 105.

In addition, the chiller 20 may be connected to the cooling apparatus 101 through the fourth line 114 through which the coolant circulates. In addition, the chiller 20 may be connected to the battery module 107 through a fifth line 115 through which the coolant circulates.

In the heating mode of the vehicle interior, in the case of recollecting waste heat of the electrical component and the ambient air heat, the fourth line 114 may be opened to connect the cooling apparatus 101 and the chiller 20.

In addition, when the battery module 107 is to be cooled in the cooling mode of the vehicle interior, or when a waste heat of the battery module 107 is to be recollected in the heating mode of the vehicle interior, the fifth line 115 may be opened to connect the chiller 20 and the battery module 107.

The coolant may selectively circulate through the first, second, third, fourth, and fifth lines 111, 112, 113, 114, and 115 by an operation of a water pump (not shown).

The electrical component may include an electric power control unit (EPCU), a motor, an inverter, an on-board charger (OBC), an autonomous driving controller, or the like.

The electric power control apparatus, the inverter, the motor, or the autonomous driving controller may generate heat while the vehicle is being driven, and the charger may generate heat when charging the battery module 107.

In other words, when the waste heat of the electrical component is to be recollected in the heating mode of the vehicle interior, the heat generated from the electric power control apparatus, motor, inverter, charger, or the autonomous driving controller may be recollected. In addition, the ambient air heat may be recollected by exchanging heat with the coolant in the radiator.

In the present embodiment, the compressor 10 may compress the supplied refrigerant. The first condenser 12 may be connected to the compressor 10 through a refrigerant line 11.

The first condenser 12 may primarily condense the refrigerant by exchanging heat between the refrigerant supplied from the compressor 10 and the coolant supplied from the cooling apparatus 101 to the first line 111.

The receiver dryer 13 may be connected to the first condenser 12 through the refrigerant line 11. The receiver dryer 13 may separate a gaseous refrigerant remaining in the refrigerant in the liquid state condensed by the first condenser 12.

In other words, the receiver dryer 13 may separate the gaseous component from the introduced refrigerant, and filter moisture and foreign substances, thereby only discharging the refrigerant in the liquid state.

The second condenser 14 may be connected to the receiver dryer 13 through the refrigerant line 11.

The second condenser 14 may additionally condense the refrigerant by exchanging heat between the refrigerant supplied from the receiver dryer 13 and an operation fluid such as air or coolant.

In the present embodiment, the evaporator 15 may be connected to the second condenser 12 through the refrigerant line 11. The evaporator 15 may evaporate the refrigerant by exchanging heat between the refrigerant supplied from the second condenser 12 through the gas injection device 30 and the coolant supplied from the cabin cooler 105.

A first end of the refrigerant connection line 21 may be connected to the refrigerant line 11 between the compressor 10 and the evaporator 15. A second end of the refrigerant connection line 21 may be connected to the gas injection device 30.

The chiller 20 may be provided in the refrigerant connection line 21. The coolant may selectively circulate inside the chiller 20 through one or all of the fourth line 114 or the fifth line 115.

In other words, the chiller 20 may be a water-cooled heat-exchanger through which coolant circulates.

Accordingly, the chiller 20 may adjust the temperature of the coolant by exchanging heat between the refrigerant introduced into the refrigerant connection line 21 and the coolant selectively introduced from one or all of the fourth line 114 and the fifth line 115.

In addition, when the ambient air heat is to be recollected in the heating mode of the vehicle interior, the chiller 20 may exchange heat between the coolant supplied from the cooling apparatus 101 to the fourth line 114 and the refrigerant to recollect the ambient air heat, and evaporate the refrigerant.

In addition, the gas injection device 30 may be provided in the refrigerant line 11 between the second condenser 14 and the evaporator 15.

The gas injection device 30 may selectively expand and flow the refrigerant supplied from the second condenser 12. The gas injection device 30 may also selectively supply a portion of the supplied refrigerant to the compressor 10 to increase the amount (e.g., flow rate) of the refrigerant circulating through the refrigerant line 11.

In the cooling mode, the heating mode, or dehumidifying mode of the vehicle interior, the gas injection device 30 is configured to be selectively operated.

The gas injection device 30 may include a gas-liquid separator 31, a supply portion 32, a first expansion valve 33, a second expansion valve 34, a third expansion valve 35, and a supply line 37.

First, the gas-liquid separator 31 may separate and selectively discharge the gaseous refrigerant and a liquid refrigerant from an interiorly introduced refrigerant.

The supply portion 32 may be connected to the second condenser 12 through the refrigerant line 11 such that the refrigerant supplied from the second condenser 12 may be introduced.

In the present embodiment, the first expansion valve 33 may be provided between the gas-liquid separator 31 and the supply portion 32, so as to selectively expand the refrigerant supplied to the supply portion 32 and supply the expanded refrigerant to the gas-liquid separator 31.

The second expansion valve 34 may be provided between the gas-liquid separator 31 and the supply portion 32. The second expansion valve 34 may be configured to selectively expand the refrigerant supplied to the supply portion 32 and supply the expanded refrigerant to the chiller 20, or to supply the refrigerant supplied from the gas-liquid separator 31 to the chiller 20.

The third expansion valve 35 may be provided between the gas-liquid separator 31 and the supply portion 32, so as to selectively expand and supply the refrigerant supplied to the supply portion 32 to the evaporator 15. Alternatively, the third expansion valve 35 may be configured to supply the refrigerant supplied from the gas-liquid separator 31 to the evaporator 15.

The first, second, and third expansion valves 33, 34, and 35 may be selectively operated at the time of air-conditioning including cooling, heating, and dehumidifying of the vehicle interior. Additionally, the first, second, and third expansion valves 33, 34, and 35 may selectively expand the refrigerant while controlling the flow of the refrigerant supplied to the gas injection device 30.

In addition, the second expansion valve 34 and the third expansion valve 35 may be 3-way electronic expansion valves selectively expanding the refrigerant while controlling the flow of the refrigerant. The second expansion valve 34 and the third expansion valve 35 have two inlets and one outlet.

In the present embodiment, the discharge portion 36 may connect the gas-liquid separator 31 to the second expansion valve 34 and the third expansion valve 35. Additionally, the discharge portion 36 may be configured to discharge the refrigerant from the gas-liquid separator 31 to the second expansion valve 34 or the third expansion valve 35.

The second expansion valve 34 and the third expansion valve 35 may be disposed in parallel with the first expansion valve 33 through the supply portion 32 and the discharge portion 36.

In addition, the supply line 37 connects the gas-liquid separator 31 to the compressor 10. When the refrigerant is supplied to the gas-liquid separator 31, the supply line 37 may selectively supply the gaseous refrigerant from the gas-liquid separator 31 to the compressor 10.

In other words, the supply line 37 may connect the gas-liquid separator 31 to the compressor 10 such that the gaseous refrigerant separated by the gas-liquid separator 31 may selectively flow into the compressor 10.

In the gas injection device 30, at the time of cooling or heating of the vehicle interior, the gas-liquid separator 31 may be operated when the first expansion valve 33 expands the refrigerant.

In other words, when the first expansion valve 33 expands the refrigerant and supplies the expanded refrigerant to the gas-liquid separator 31, the gas-liquid separator 31 may supply the gaseous refrigerant, among the supplied refrigerant, to the compressor 10 through the supply line 37, to increase the flow rate of the refrigerant circulating through the refrigerant line 11.

In the heat pump system configured as such, the flow of the refrigerant may be controlled according to at least one mode for adjusting a temperature of the vehicle interior or adjusting a temperature of the battery module.

The at least one mode may include a first mode to a fourth mode.

In the first mode, the gas-liquid separator 31 may be operated, and the battery module 107 may be cooled while the vehicle interior is cooled.

In the second mode, the gas-liquid separator 31 may be operated, and the vehicle interior may be heated.

In the third mode, the gas-liquid separator 31 may not be operated (i.e., blocked, closed, turned off, or the like), and the battery module 107 may be cooled while the vehicle interior is cooled.

In addition, in the fourth mode, the gas-liquid separator 31 may not be operated, and the vehicle interior may be heated.

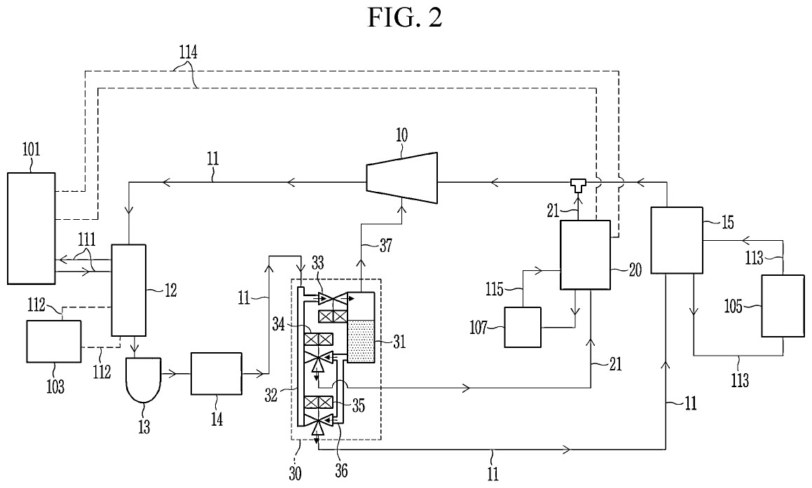

An operation and action of a heat pump system according to an embodiment is described in detail with reference to FIGS. 2-5.

First, the operation according to the first mode of a heat pump system for a vehicle according to an embodiment in which the gas-liquid separator 31 is operated in the cooling mode of the vehicle interior and the battery module 107 is cooled is described with reference to FIG. 2.

FIG. 2 is an operation diagram illustrating a heat pump system for a vehicle according to an embodiment, in a first mode.

Referring to FIG. 2, in the first mode, the first expansion valve 33 may expand the refrigerant supplied through the supply portion 32 and supply the expanded refrigerant to the gas-liquid separator 31. The supply line 37 may be opened.

Accordingly, the gas-liquid separator 31 may supply the gaseous refrigerant among the interiorly introduced refrigerant to the compressor 10 through the opened supply line 37.

In other words, the gas injection device 30 may increase the flow rate of the refrigerant circulating through the refrigerant line 11, by returning the gaseous refrigerant separated while passing through the gas-liquid separator 31 back to the compressor 10 through the supply line 37.

Simultaneously, the second expansion valve 34 may expand the refrigerant supplied from the gas-liquid separator 31 through the discharge portion 36 and flow the expanded refrigerant to the refrigerant connection line 21 connected to the chiller 20.

The refrigerant introduced into the refrigerant connection line 21 may flow into the chiller 20. The refrigerant introduced into the chiller 20 may exchange heat with the coolant supplied from the battery module 107 through the fifth line 115, and thereby cool the coolant.

The coolant cooled in the chiller 20 may be supplied to the battery module 107 along the fifth line 115. Accordingly, the battery module 107 may be efficiently cooled by the coolant cooled at the chiller 20.

In other words, the coolant circulating the fifth line 115 may efficiently cool the battery module 107 by repeatedly performing the above-described operation.

In addition, the third expansion valve 35 may expand the refrigerant supplied from the gas-liquid separator 31 through the discharge portion 36 and flow the expanded refrigerant to the refrigerant line 11.

In other words, the liquid refrigerant stored in the gas-liquid separator 31 may flow into the chiller 20 along the refrigerant connection line 21 in a state expanded by an operation of the second expansion valve 34.

In addition, the liquid refrigerant stored in the gas-liquid separator 31 may flow into the evaporator 15 along the refrigerant line 11 in a state expanded by an operation of the third expansion valve 35.

The refrigerant introduced into the evaporator 15 may be evaporated by exchanging heat with the coolant supplied from the cabin cooler 105 to the third line 113.

The ambient air introduced into the vehicle interior may be cooled by exchanging heat with the low temperature coolant introduced into the cabin cooler 105. Therefore, the cooled ambient air may cool the vehicle interior, by being directly drawn to the vehicle interior.

The refrigerant having passed through the evaporator 15 and the chiller 20 may flow into the compressor 10.

In other words, the refrigerant having passed through the evaporator 15 and the chiller 20, and the refrigerant supplied from the gas-liquid separator 31 through the supply line 37 may flow together into the compressor 10. The introduced refrigerant may be compressed by an operation of the compressor 10.

The refrigerant compressed in the compressor 10 may be supplied to the first condenser 12. The first condenser 12 may condense the refrigerant by using the coolant supplied from the cooling apparatus 101 through the opened first line 111.

The refrigerant condensed in the first condenser 12 may flow into the receiver dryer 13 along the refrigerant line 11. The receiver dryer 13 may separate the gaseous component from the introduced refrigerant, and filter moisture and foreign substances, thereby only discharging the refrigerant in the liquid state.

The refrigerant discharged from the receiver dryer 13 may be supplied to the second condenser 14 along the refrigerant line 11. The second condenser 14 may additionally condense the refrigerant by exchanging heat between the refrigerant supplied from the receiver dryer 13 and an operation fluid such as air or coolant.

The refrigerant additionally condensed in the second condenser 14 may be supplied to the gas injection device 30.

The heat pump system according to an embodiment may increase the amount of refrigerant flowing along the refrigerant line 11, while repeatedly performing the above-described operation.

In addition, the heat pump system may improve overall cooling performance and efficiency, and efficiently cool the vehicle interior, by increasing the amount of refrigerant flowing along the refrigerant line 11.

Simultaneously, the heat pump system may efficiently cool the battery module 107 by using the low-temperature coolant cooled in the chiller 20.

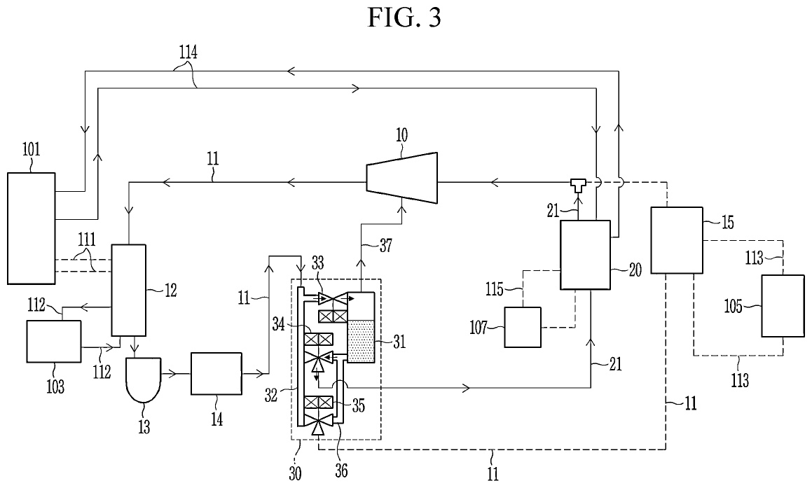

The operation according to the second mode of a heat pump system for a vehicle according to an embodiment is described with reference to FIG. 3. In the second mode (i.e., the heating mode of the vehicle interior), the gas-liquid separator 31 may be operated, and the waste heat of the ambient air heat and the electrical component is recollected.

FIG. 3 is an operation diagram illustrating a heat pump system for a vehicle according to an embodiment in a second mode.

Referring to FIG. 3, when the gas-liquid separator 31 is operated, the heat pump system may absorb the ambient air heat and the waste heat of the electrical component from the coolant supplied from the cooling apparatus 101.

The ambient air heat may be absorbed by exchanging heat between the coolant passing through the radiator and the ambient air.

In other words, when the gas-liquid separator 31 is operated in the second mode, the first expansion valve 33 may expand the refrigerant supplied through the supply portion 32 and supply the expanded refrigerant to the gas-liquid separator 31. The supply line 37 may be opened.

Accordingly, the gas-liquid separator 31 may supply the gaseous refrigerant, among the interiorly introduced refrigerant, to the compressor 10 through the opened supply line 37.

In other words, the gas injection device 30 may increase the flow rate of the refrigerant circulating through the refrigerant line 11, by returning the gaseous refrigerant separated while passing through the gas-liquid separator 31 back to the compressor 10 through the supply line 37.

Simultaneously, the second expansion valve 34 may expand the refrigerant supplied from the gas-liquid separator 31 through the discharge portion 36 and flow the expanded refrigerant to the refrigerant connection line 21 connected to the chiller 20.

In addition, the third expansion valve 35 may stop operating.

Accordingly, the refrigerant introduced through the refrigerant connection line 21 may flow into the chiller 20. The refrigerant introduced into the chiller 20 may exchange heat with the coolant supplied from the cooling apparatus 101 through the fourth line 114, and thereby cool the coolant.

The coolant may absorb the ambient air heat while passing through the radiator and have its temperature increased. The coolant may absorb the waste heat of the electrical component and have its temperature increased. The coolant heated through such an operation may be supplied to the chiller 20.

The chiller 20 may recollect the waste heat of the ambient air heat and the electrical component while exchanging heat between the coolant supplied from the cooling apparatus 101 to the fourth line 114 and the refrigerant.

In other words, the liquid refrigerant stored in the gas-liquid separator 31 may flow into the chiller 20 along the refrigerant connection line 21, in an expanded state through an operation of the second expansion valve 34.

The refrigerant having passed through the chiller 20 may flow into the compressor 10.

In other words, the refrigerant having passed through the chiller 20, and the refrigerant supplied from the gas-liquid separator 31 through the supply line 37 may be introduced into the compressor 10. The introduced refrigerant may be compressed by the operation of the compressor 10.

The refrigerant compressed at the compressor 10 is supplied to the first condenser 12. The first condenser 12 may condense the refrigerant by using the coolant supplied from the heater core 103 through the opened second line 112.

Accordingly, the coolant heated by exchanging heat with the refrigerant at the first condenser 12 may be supplied to the heater core 103.

The first line 111, the third line 113, and the fifth line 115 may be closed.

In addition, the refrigerant condensed in the first condenser 12 may flow into the receiver dryer 13 along the refrigerant line 11. The receiver dryer 13 may separate the gaseous component from the introduced refrigerant, and filter moisture and foreign substances, thereby only discharging the refrigerant in the liquid state.

The refrigerant discharged from the receiver dryer 13 may be supplied to the second condenser 14 along the refrigerant line 11. The second condenser 14 may additionally condense the refrigerant by exchanging heat between the refrigerant supplied from the receiver dryer 13 and an operation fluid such as air or coolant.

The refrigerant additionally condensed in the second condenser 14 may be supplied to the gas injection device 30.

The ambient air introduced into the vehicle interior is converted to the high-temperature state by exchanging heat with the coolant in the high-temperature state introduced into the heater core 103, and then introduced to the vehicle interior, thereby realizing heating of the vehicle interior.

Accordingly, the refrigerant circulating through the heat pump system may smoothly recollect, in the chiller 20, the waste heat from the coolant having its temperature increased due to the ambient air heat and while passing through the electrical component. Accordingly, the overall heating performance and efficiency may be improved.

In addition, according to the present disclosure, the heating efficiency and performance may be improved while minimizing the usage of a separate electric heater.

In addition, heating performance may be maximized by increasing the flow rate of the refrigerant circulating through the refrigerant line 11 by the gas injection device 30.

In the present embodiment, it has been described that the ambient air heat and the waste heat of the electrical component are recollected together, but it is not limited thereto. At least one of the ambient air heat, the waste heat of the electrical component, or the waste heat of the battery module 107 may be selectively recollected.

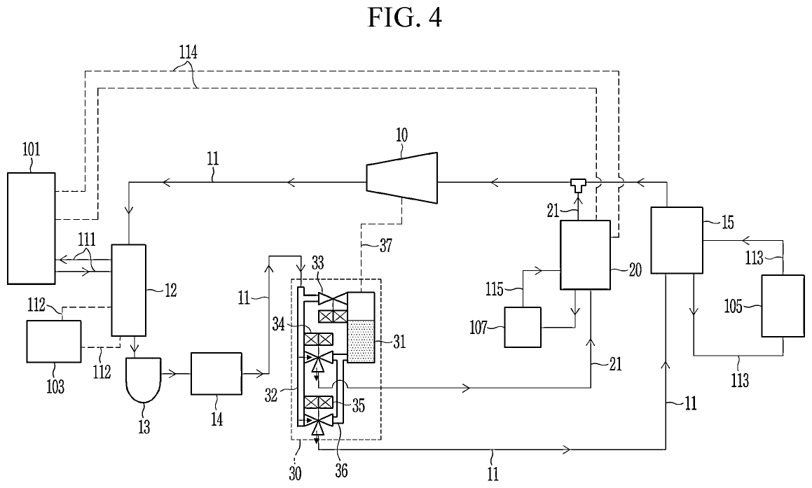

The operation according to the third mode of a heat pump system for a vehicle according to an embodiment is described with reference to FIG. 4. In the third mode (i.e., in the cooling mode of the vehicle interior), the gas-liquid separator 31 may not be operated, and the battery module 107 is cooled.

FIG. 4 is an operation diagram illustrating a heat pump system for a vehicle according to an embodiment in a third mode.

Referring to FIG. 4, in the third mode, the operation of the gas-liquid separator 31 is not required, and when cooling the battery module 107, the first expansion valve 33 stops operating.

Accordingly, the flow of the refrigerant into the gas-liquid separator 31 may be blocked. In addition, the supply line 37 may be closed.

Simultaneously, the second expansion valve 34 may expand the refrigerant supplied from the second condenser 14 through the supply portion 32 and flow the expanded refrigerant to the refrigerant connection line 21 connected to the chiller 20.

The refrigerant introduced through the refrigerant connection line 21 may flow into the chiller 20. The refrigerant introduced into the chiller 20 may exchange heat with the coolant supplied from the battery module 107 through the fifth line 115, and thereby cool the coolant.

The coolant cooled in the chiller 20 may be supplied to the battery module 107 along the fifth line 115. Accordingly, the battery module 107 may be efficiently cooled by the coolant cooled at the chiller 20.

In other words, the coolant circulating the fifth line 115 may efficiently cool the battery module 107 by repeatedly performing the above-described operation.

In addition, the third expansion valve 35 may expand the refrigerant supplied from the second condenser 14 through the supply portion 32 and flow the expanded refrigerant to the refrigerant line 11.

In other words, the refrigerant introduced into the supply portion 32 may flow into the evaporator 15 along the refrigerant line 11 in a state expanded by an operation of the third expansion valve 35.

The refrigerant introduced into the evaporator 15 may be evaporated exchanging heat with the coolant supplied from the cabin cooler 105 to the third line 113.

The ambient air introduced into the vehicle interior is cooled by exchanging heat with the coolant in a low temperature state drawn into the cabin cooler 105. Therefore, the cooled ambient air may cool the vehicle interior, by being directly drawn to the vehicle interior.

The refrigerant having passed through the evaporator 15 may flow into the compressor 10. The refrigerant introduced into the compressor 10 may be compressed by the operation of the compressor 10.

The refrigerant compressed in the compressor 10 may be supplied to the first condenser 12. At this time, the first condenser 12 may condense the refrigerant by using the coolant supplied from the cooling apparatus 101 through the opened first line 111.

The refrigerant condensed in the first condenser 12 may flow into the receiver dryer 13 along the refrigerant line 11. The receiver dryer 13 may separate the gaseous component from the introduced refrigerant, and filter moisture and foreign substances, thereby only discharging the refrigerant in the liquid state.

The refrigerant discharged from the receiver dryer 13 may be supplied to the second condenser 14 along the refrigerant line 11. The second condenser 14 may additionally condense the refrigerant by exchanging heat between the refrigerant supplied from the receiver dryer 13 with an operation fluid such as air or coolant.

The refrigerant additionally condensed in the second condenser 14 may be supplied to the supply portion 32 provided in the gas injection device 30.

The heat pump system according to an embodiment may efficiently cool the vehicle interior in the third mode, while repeatedly performing the above-described processes.

Simultaneously, the heat pump system may efficiently cool the battery module 107 by using the low temperature coolant cooled at the chiller 20.

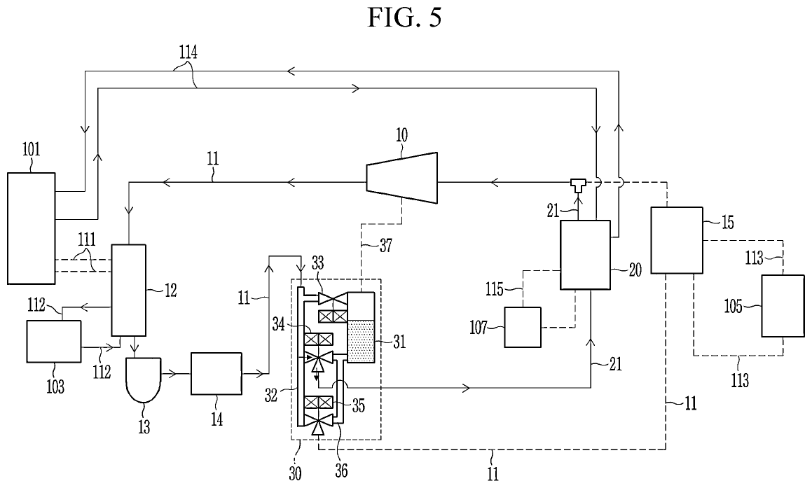

The operation according to the fourth mode of a heat pump system for a vehicle according to an embodiment is described with reference to FIG. 5. In the fourth mode, (i.e., in the heating mode of the vehicle), the gas-liquid separator 31 may not be operated and the waste heat of the ambient air heat and the electrical component is recollected.

FIG. 5 is an operation diagram illustrating a heat pump system for a vehicle according to an embodiment in a fourth mode.

Referring to FIG. 5, when the gas-liquid separator 31 is not operated, the heat pump system may absorb the ambient air heat and the waste heat of the electrical component from the coolant supplied from the cooling apparatus 101.

The ambient air heat may be absorbed by exchanging heat between the coolant passing through the radiator and the ambient air.

in other words, when the gas-liquid separator 31 is not operated in the fourth mode, the first expansion valve 33 stops operating.

Accordingly, the flow of the refrigerant into the gas-liquid separator 31 may be blocked. In addition, the supply line 37 may be closed.

Simultaneously, the second expansion valve 34 may expand the refrigerant supplied from the second condenser 14 through the supply portion 32 and flow the expanded refrigerant to the refrigerant connection line 21 connected to the chiller 20.

In addition, the third expansion valve 35 may stop operating.

Accordingly, the refrigerant introduced into the refrigerant connection line 21 may flow into the chiller 20. The refrigerant introduced into the chiller 20 may exchange heat with the coolant supplied from the cooling apparatus 101 through the fourth line 114, and thereby cool the coolant.

The coolant may absorb the ambient air heat while passing through the radiator and increase in temperature. The coolant may also absorb the waste heat of the electrical component and increase in temperature. The increased temperature coolant through such an operation may be supplied to the chiller 20.

The chiller 20 may recollect the waste heat of the ambient air heat and the electrical component while exchanging heat between the coolant supplied from the cooling apparatus 101 to the fourth line 114 and the refrigerant.

In other words, the refrigerant discharged from the second condenser 14 may flow into the chiller 20 along the refrigerant connection line 21 in a state expanded by an operation of the second expansion valve 34.

The refrigerant having passed through the chiller 20 may flow into the compressor 10.

In other words, the refrigerant having passed through the chiller 20 may flow into the compressor 10. The introduced refrigerant may be compressed by the operation of the compressor 10.

The refrigerant compressed in the compressor 10 may be supplied to the first condenser 12. The first condenser 12 may condense the refrigerant by using the coolant supplied from the heater core 103 through the opened second line 112.

Accordingly, the coolant having increased in temperature by exchanging heat with the refrigerant in the first condenser 12 may be supplied to the heater core 103.

The first line 111, the third line 113, and the fifth line 115 may be closed.

In addition, the refrigerant condensed in the first condenser 12 may flow into the receiver dryer 13 along the refrigerant line 11. The receiver dryer 13 may separate the gaseous component from the introduced refrigerant, and filter moisture and foreign substances, thereby only discharging the refrigerant in the liquid state.

The refrigerant discharged from the receiver dryer 13 may be supplied to the second condenser 14 along the refrigerant line 11. The second condenser 14 may additionally condense the refrigerant by exchanging heat between the refrigerant supplied from the receiver dryer 13 and an operation fluid such as air or coolant.

In addition, the refrigerant additionally condensed in the second condenser 14 may flow into the supply portion 32.

The ambient air introduced into the vehicle interior is converted to the high-temperature state by exchanging heat with the coolant in the high-temperature state introduced into the heater core 103, and then introduced to the vehicle interior, thereby realizing heating of the vehicle interior.

Accordingly, the refrigerant circulating through the heat pump system may smoothly recollect, in the chiller 20, the waste heat from the coolant having increased in temperature due to the ambient air heat and while passing through the electrical component. Accordingly, the overall heating performance and efficiency may be improved.

In addition, the present disclosure may enhance the heating efficiency and performance, while minimizing the use of a separate electric heater.

As described in the present disclosure, the ambient air heat and the waste heat of the electrical component are recollected, however the present disclosure is not limited thereto. At least one of the ambient air heat, the waste heat of the electrical component, and the waste heat of the battery module 107 may be selectively recollected.

Therefore, as described above, according to a heat pump system for a vehicle according to an embodiment, the waste heat of the electrical component may be recollected and the temperature of the battery module 107 may be adjusted, depending on the mode of the vehicle. This is achieved by using the single chiller 20 where the coolant and the refrigerant exchange heat.

In addition, according to the present disclosure, cooling and heating performance may be improved by applying the gas injection device 30 to selectively operate for air conditioning of the vehicle interior to increase the flow rate of the refrigerant.

In addition, according to the present disclosure, performance of the system may be maximized by using the gas injection device while minimizing the number of required components, and thus streamlining and simplifying the system.

In addition, according to an embodiment, by efficiently adjusting the temperature of the battery module 107, the optimal performance of the battery module 107 may be enabled, and the overall travel distance of the vehicle may be increased due to the efficient management of the battery module 107.

In addition, according to the present disclosure, heating efficiency may be enhanced by selectively utilizing the ambient air heat, the waste heat of the electrical component, or the waste heat of the battery module 107 in the heating mode of the vehicle.

In addition, according to an embodiment, it is possible to reduce manufacturing cost and weight through simplification of an entire system, and to improve space utilization.

While the present inventive concept has been described in connection with what is presently considered to be practical embodiments, it should be understood that the disclosure is not limited to the disclosed embodiments. On the contrary, it is intended to cover various modifications and equivalent arrangements included within the spirit and scope of the appended claims.

### DESCRIPTION OF SYMBOLS

10: compressor
11: refrigerant line
12: first condenser
13: receiver dryer
14: second condenser
15: evaporator
20: chiller
21: refrigerant connection line
30: gas injection device
31: gas-liquid separator
32: supply portion
33, 34, 35: first, second, and third expansion valve
36: discharge portion
37: supply line
101: cooling apparatus
103: heater core
105: cabin cooler
107: battery module
111, 112, 113, 114, 115: first, second, third, fourth, and fifth line

What is claimed is:

1. A heat pump system for a vehicle, the heat pump system comprising:
a compressor configured to compress a refrigerant;
a first condenser connected to the compressor through a refrigerant line, and configured to receive and condense the refrigerant supplied from the compressor by exchanging heat between a coolant and the refrigerant supplied from the compressor;
a receiver dryer connected to the first condenser through the refrigerant line;
a second condenser connected to the receiver dryer through the refrigerant line;
an evaporator connected to the second condenser through the refrigerant line, and configured to evaporate the refrigerant by exchanging heat between the refrigerant supplied from the second condenser and a selectively introduced coolant;
a gas injection device connected to the refrigerant line between the second condenser and the evaporator, wherein the gas injection device is configured to selectively expand and flow the refrigerant supplied from the second condenser, and further configured to selectively supply a portion of the supplied refrigerant to the compressor to increase a flow rate of the refrigerant circulating in the refrigerant line;
a refrigerant connection line disposed between the compressor and the evaporator, and including: a first end connected to the refrigerant line, and a second end connected to the gas injection device; and
a chiller provided in the refrigerant connection line, and configured to adjust a temperature of the coolant by exchanging heat between the refrigerant supplied into the refrigerant connection line and a selectively introduced coolant,
wherein the flow of the refrigerant is controlled according to at least one mode for adjusting a temperature of a vehicle interior or adjusting a temperature of a battery module.

2. The heat pump system of claim 1, wherein the gas injection device comprises:
a supply portion connected to the second condenser through the refrigerant line such that the refrigerant supplied from the second condenser may be introduced;
a gas-liquid separator configured to separate and selectively discharge a gaseous refrigerant and a liquid refrigerant from the refrigerant supplied by the supply portion;
a first expansion valve provided between the gas-liquid separator and the supply portion, the first expansion valve being configured to selectively expand the refrigerant supplied to the supply portion and supply the expanded refrigerant to the gas-liquid separator;
a second expansion valve provided between the gas-liquid separator and the supply portion, wherein the second expansion valve is configured to either selectively expand the refrigerant supplied to the supply portion and supply the expanded refrigerant to the chiller, or supply the refrigerant supplied from the gas-liquid separator to the chiller;
a third expansion valve provided between the gas-liquid separator and the supply portion, wherein the third expansion valve is configured to either selectively expand the refrigerant supplied to the supply portion and supply the expanded refrigerant to the evaporator, or supply the refrigerant supplied from the gas-liquid separator to the evaporator;
a discharge portion connecting the gas-liquid separator, the second expansion valve, and the third expansion valve, wherein the discharge portion is configured to discharge the refrigerant from the gas-liquid separator to the second expansion valve or the third expansion valve; and
a supply line connecting the gas-liquid separator and the compressor, and configured to selectively supply the gaseous refrigerant from the gas-liquid separator to the compressor.

3. The heat pump system of claim 2, wherein the second expansion valve and the third expansion valve are disposed in parallel with the first expansion valve through the supply portion and the discharge portion.

4. The heat pump system of claim 2, wherein the first, second, and third expansion valves are selectively operated when air-conditioning the vehicle interior by cooling, heating, and dehumidifying, and wherein the first, second, and third expansion valves selectively expand the refrigerant via the gas injection device while controlling the flow of the supplied refrigerant.

5. The heat pump system of claim 2, wherein the gas-liquid separator is operated when the first expansion valve expands the refrigerant, and wherein the gas-liquid separator is configured to supply the gaseous refrigerant among the supplied refrigerant to the compressor through the supply line to increase the flow rate of the refrigerant circulating in the refrigerant line.

6. The heat pump system of claim 2, wherein the at least one mode comprises:
a first mode in which the gas-liquid separator is operated, and the battery module is cooled while the vehicle interior is cooled;
a second mode in which the gas-liquid separator is operated, and the vehicle interior is heated;
a third mode in which the gas-liquid separator is not operated, and the battery module is cooled while cooling the vehicle interior; and
a fourth mode in which the gas-liquid separator is not operated, and the vehicle interior is heated.

7. The heat pump system of claim 6, wherein in the first mode:
the first expansion valve expands the refrigerant supplied through the supply portion and supplies the expanded refrigerant to the gas-liquid separator;
the second expansion valve expands the refrigerant supplied from the gas-liquid separator through the discharge portion and flows the expanded refrigerant to the refrigerant connection line connected to the chiller;
the third expansion valve expands the refrigerant supplied from the gas-liquid separator through the discharge portion and flows the expanded refrigerant to the refrigerant line;
the supply line is opened; and
the gas-liquid separator supplies the gaseous refrigerant among the refrigerant supplied by the supply portion to the compressor through the opened supply line.

8. The heat pump system of claim 6, wherein, in the second mode:
the first expansion valve expands the refrigerant supplied through the supply portion and supplies the expanded refrigerant to the gas-liquid separator;
the second expansion valve expands the refrigerant supplied from the gas-liquid separator through the discharge portion and flows the expanded refrigerant to the refrigerant connection line connected to the chiller;
the third expansion valve stops operating;
the supply line is opened; and
the gas-liquid separator supplies the gaseous refrigerant among the refrigerant supplied by the supply portion to the compressor through the opened supply line.

9. The heat pump system of claim 6, wherein, in the third mode:
the first expansion valve stops operating such as to stop the flow of the refrigerant to the gas-liquid separator;
the second expansion valve expands the refrigerant supplied through the supply portion and supplies the expanded refrigerant to the gas-liquid separator through the refrigerant connection line;
the third expansion valve expands the refrigerant supplied through the supply portion and supplies the expanded refrigerant to the gas-liquid separator through the refrigerant line; and
the supply line is closed.

10. The heat pump system of claim 6, wherein, in the fourth mode:
the first expansion valve and the third expansion valve stop operating such as to stop the flow of the refrigerant to the gas-liquid separator;
the second expansion valve expands the refrigerant supplied through the supply portion and flows the expanded refrigerant to the refrigerant connection line connected to the chiller; and
the supply line is closed.

11. The heat pump system of claim 2, wherein the second expansion valve and the third expansion valve are 3-way electronic expansion valves having two inlets and one outlet, and configured to selectively expand the refrigerant while controlling the flow of the refrigerant.

12. The heat pump system of claim 2, further comprising a cooling apparatus including a radiator and an electrical component,
wherein the cooling apparatus is connected to a battery module, and
wherein the first condenser is connected to the cooling apparatus through a first line through which the coolant circulates, and connected to a heater core through a second line through which the coolant circulates.

13. The heat pump system of claim 12, wherein, in a cooling mode and a heating mode of the vehicle interior, the first line is selectively opened to supply the coolant to the first condenser.

14. The heat pump system of claim 12, wherein, in a heating mode of the vehicle interior, the second line is opened to connect the first condenser and the heater core.

15. The heat pump system of claim 12, wherein the evaporator is connected to a cabin cooler through a third line through which the coolant circulates.

16. The heat pump system of claim 15, wherein, in a cooling mode of the vehicle interior, the third line is opened to connect the evaporator and the cabin cooler.

17. The heat pump system of claim 12, wherein the chiller is connected to the cooling apparatus through a fourth line through which the coolant circulates, and connected to the battery module through a fifth line through which the coolant circulates.

18. The heat pump system of claim 17, wherein, in a heating mode of the vehicle interior, when waste heat of the electrical component and ambient air heat is recollected, the fourth line is opened to connect the cooling apparatus and the chiller.

19. The heat pump system of claim 17, wherein, in cooling the battery module in a cooling mode of the vehicle interior, or when a waste heat of the battery module is recollected in a heating mode of the vehicle, the fifth line is opened to connect the chiller and the battery module.
